(19) United States
(12) Patent Application Publication
(10) Pub. No.: US 2012/0078622 A1
(43) Pub. Date: Mar. 29, 2012

(54) SPOKEN DIALOGUE APPARATUS, SPOKEN DIALOGUE METHOD AND COMPUTER PROGRAM PRODUCT FOR SPOKEN DIALOGUE

(75) Inventors: Kenji Iwata, Kanagawa-ken (JP); Takehide Yano, Tokyo (JP)

(73) Assignee: KABUSHIKI KAISHA TOSHIBA, Tokyo (JP)

(21) Appl. No.: 13/051,144

(22) Filed: Mar. 18, 2011

(30) Foreign Application Priority Data
Sep. 28, 2010 (JP) 2010-217487

(51) Int. Cl. G10L 15/00

(52) U.S. Cl. 704/231; 704/E15.002

(57) ABSTRACT

According to one embodiment, a spoken dialogue apparatus includes a detection unit configured to detect speech of a user; a recognition unit configured to recognize the speech; an output unit configured to output a response voice corresponding to the result of speech recognition; an estimate unit configured to estimate probability variation of a barge-in utterance, the probability variation of the barge-in utterance being the time variation of the probability of arising the barge-in utterance interrupted by the user during outputting the response voice; and a control unit configured to determine whether to adopt the barge-in utterance based on the probability variation of the barge-in utterance.

### CROSS REFERENCE TO RELATED APPLICATION

This application is based upon and claims the benefit of priority from Japanese Patent Application No. 2010-217487, filed on Sep. 28, 2010; the entire contents of which are incorporated herein by reference.

### FIELD

Embodiments described herein relate generally to a spoken dialogue apparatus.

### BACKGROUND

A spoken dialogue apparatus interacts with a user. The apparatus recognizes voice inputted by the user, selects one of candidate responses corresponding to the voice, and outputs voice of the selected response. The apparatus has a barge-in function that recognizes a barge-in utterance. The barge-in utterance is voice interrupted by the user when the apparatus outputs voice of the response.

It is expected that the apparatus is able to recognize the barge-in speech highly.

### BRIEF DESCRIPTION OF THE DRAWINGS

FIG. 1 shows the entire of a spoken dialogue apparatus 1 according to a first embodiment.

FIG. 2 illustrates a flow chart of the operation of the apparatus 1.

FIGS. 3A and 3B illustrate a method that an estimate unit 15 estimates probability variation of the barge-in utterance.

FIGS. 4A to 4C illustrate another method that an estimate unit 15 estimates probability variation of the barge-in utterance.

FIG. 5 illustrates another method that an estimate unit 15 estimates probability variation of the barge-in utterance.

FIG. 6 illustrates a flow chart of the operation of the apparatus 1 according to a first variation of the first embodiment.

FIG. 7 illustrates a flow chart of the operation of the apparatus 10 according to a second variation of the first embodiment.

FIG. 8 shows the entire of a spoken dialogue apparatus 2 according to a second embodiment.

FIG. 9 illustrates a flow chart of the operation of the apparatus 2.

FIGS. 10A to 10B illustrate a method that an estimate unit 25 estimates probability variation of the barge-in utterance.

FIG. 11 shows the entire of a spoken dialogue apparatus 3 according to a third embodiment.

FIG. 12 illustrates a flow chart of the operation of the apparatus 3.

FIGS. 13A to 13B illustrate a method that an estimate unit 35 estimates probability variation of the barge-in utterance.

FIG. 14 shows the entire of a spoken dialogue apparatus 4 according to a fourth embodiment.

FIG. 15 illustrates a flow chart of the operation of the apparatus 4.

### DETAILED DESCRIPTION

According to one embodiment, a spoken dialogue apparatus includes a detection unit configured to detect speech of a user; a recognition unit configured to recognize the speech; an output unit configured to output a response voice corresponding to the result of speech recognition; an estimate unit configured to estimate probability variation of a barge-in utterance, the probability variation of the barge-in utterance being the time variation of the probability of arising the barge-in utterance interrupted by the user during outputting the response voice; and a control unit configured to determine whether to adopt the barge-in utterance based on the probability variation of the barge-in utterance.

Various Embodiments will be described hereinafter with reference to the accompanying drawings.

### First Embodiment

A spoken dialogue apparatus 1 according to a first embodiment interacts with a user and controls a system 100 (ex. Hands-free dial system or Car navigation system). The apparatus 1 has a function of barge-in. The barge-in utterance is voice interrupted by the user when the apparatus outputs voice of a response. Hereinafter, it is explained that the apparatus 1 controls the hands-free dial system.

The apparatus 1 determines whether to receive barge-in speech during outputting a response voice, using the system action or the response voice. The apparatus 1 determines whether to receive a barge-in utterance on the basis of probability variation of the barge-in utterance. The probability variation of the barge-in utterance is based upon the time variation of the probability that the barge-in utterance arises during outputting the response voice.

The apparatus 1 reduces false detections of barge-in utterances caused by user's mutter (e.g. mumble to oneself) and noise (e.g. background noise), while the barge-in utterance is not in fact arisen.

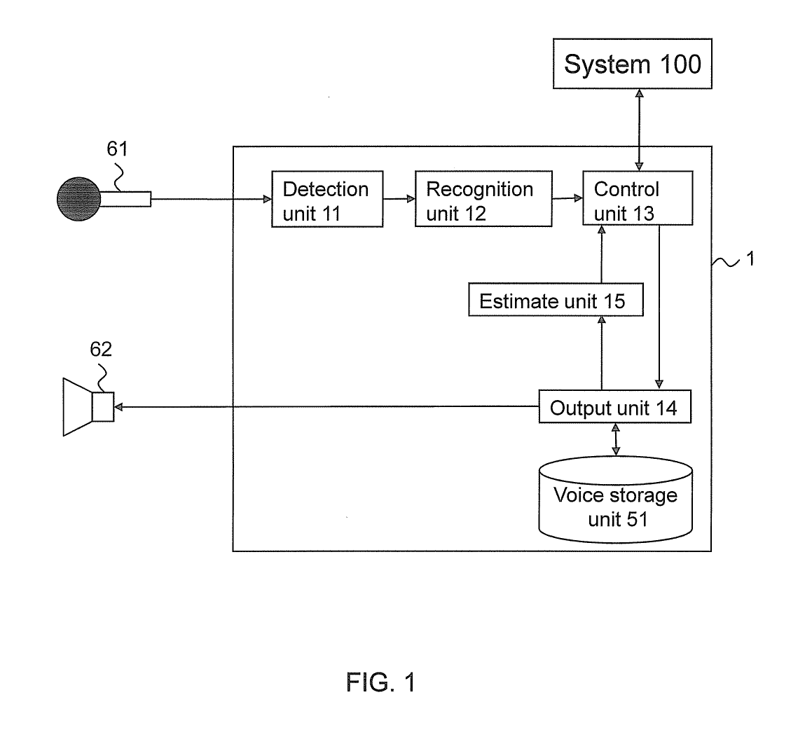

FIG. 1 shows the entire of the spoken dialogue apparatus 1. The apparatus 1 includes a detection unit 11, a recognition unit 12, a control unit 13, an output unit 14, an estimate unit 15, a produce unit 16 and a voice storage unit 51. The apparatus is connected to a microphone 61 and a speaker (loudspeaker) 62.

The detection unit 11 detects a user's voice (voice signal) inputted by the microphone 61. The recognition unit 12 recognizes the detected user's voice.

The control unit 13 determines the system action on the basis of the result of the speech recognition. The system action is all of the setting action of the system 100 in the following dialogues. For example, the system action is to inform user of information, output method of the response voice to request user's reply, or to be capable of input what kind of voice in that case.

The method of determining the system action is well-known. For example, one method is that the control unit 13 manages progress of a situation of a dialogue with a user, changes state on the basis of the result of the speech recognition, and determines the system action according to the state. Another method is that the control unit 13 determines the system action from the result of the speech recognition based on the predetermined rule.

The control unit 13 adjusts the standard of whether to adopt the barge-in utterance based on the probability variation of the barge-in utterance, when the system action is determined. The probability variation of the barge-in utterance is estimated by estimate unit 15.

For example, the control unit 13 calculated the reliability of the result of the speech recognition by using a well-known speech recognition technique. The reliability is adopted as the standard.

The voice storage unit 51 stores voice data for outputting the response voice. The output unit 14 selects or produces the voice data, by using a well-known speech synthesis technique, according to the system action from the voice storage unit 51, and outputs the response voice (voice signal) to the speaker 62. The speaker 62 output the response voice to the user. The output unit 14 output the response voice to the estimate unit 15.

The estimate unit 15 beforehand estimates the probability variation of the barge-in utterance based on the response voice outputted the output unit 14, if the system 100 outputs a next response voice, and outputs the estimated probability variation of the barge-in utterance to the control unit 13.

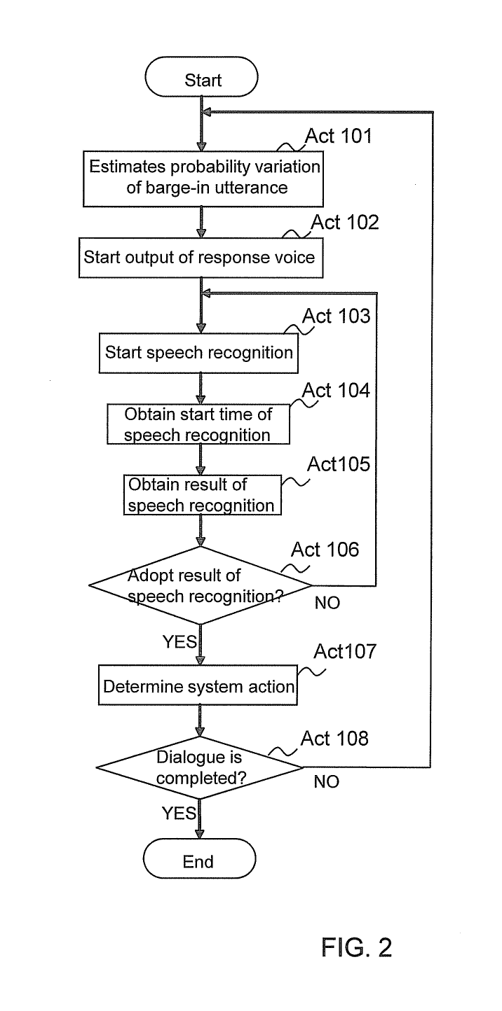

FIG. 2 illustrates a flow chart of the operation of the spoken dialogue apparatus 1. When the apparatus 1 is started up, the estimate unit 15 starts to estimate the probability variation of the barge-in utterance. The estimate unit 15 estimates the probability variation of the barge-in utterance during outputting the early response voice, based on the early response voice outputted by the output unit 14 (Act 101).

The output unit 14 starts an output of the response voice (Act 102). The recognition unit 12 starts speech recognition (Act 103). Act 102 and Act 103 can be performed in reverse order or at the same time.

While the recognition unit 12 performs speech recognition, the detection unit 11 detects a voice between starting the speech recognition and obtaining the result of the speech recognition. The detection unit 11 stores the start time of the speech detection (Act 104).

If the recognition unit 12 obtains the result of the speech recognition (Act 105), the control unit 13 determines whether to adopt the result of the speech recognition based on the probability variation of the barge-in utterance (Act 106).

That it to say, the control unit 13 makes it easier to adopt the result of the speech recognition at the time when it is estimated that the barge-in utterance is more likely to arise, or makes it more difficult to adopt the result of the speech recognition at the time when it is estimated that the barge-in utterance is unlikely to arise.

If it is determined not to adopt the result of the speech recognition (reference “NO” of Act 106), it is transited to Act 103. In this case, if the response voice is outputted from the speaker 62, even so the recognition unit 12 restarts the speech recognition.

If it is determined to adopt the result of the speech recognition (reference “YES” of Act 106), the control unit 13 determines the system action to be performed next (Act 107). The control unit 13 determines whether to complete the dialogue with the user (Act 108). For example, if voice inputted by the user is not performed in predetermined time, the control unit 13 determines that the dialogue with the user is completed.

If the control unit 13 determines that the dialogue with the user is completed (reference “YES” of Act 108), the operation of the apparatus 1 is finished.

If the control unit 13 determines that the dialogue with the user is not completed (reference “NO” of Act 108), it is transited to Act 101.

In the Act 102, the next response voice is outputted on the basis of the determined system action. If the next response voice is outputted during outputting the previous response voice, the outputted previous response voice is interrupted. The timing to interrupt is set as a period from the time when the detection unit 11 starts to detect the voice (Act 104) to the time of outputting the next response (Act 102).

The control unit 13 is able to control whether to adopt the obtained result of the speech recognition based on the probability variation of the barge-in utterance, when the detection unit 11 starts to detect the user's voice.

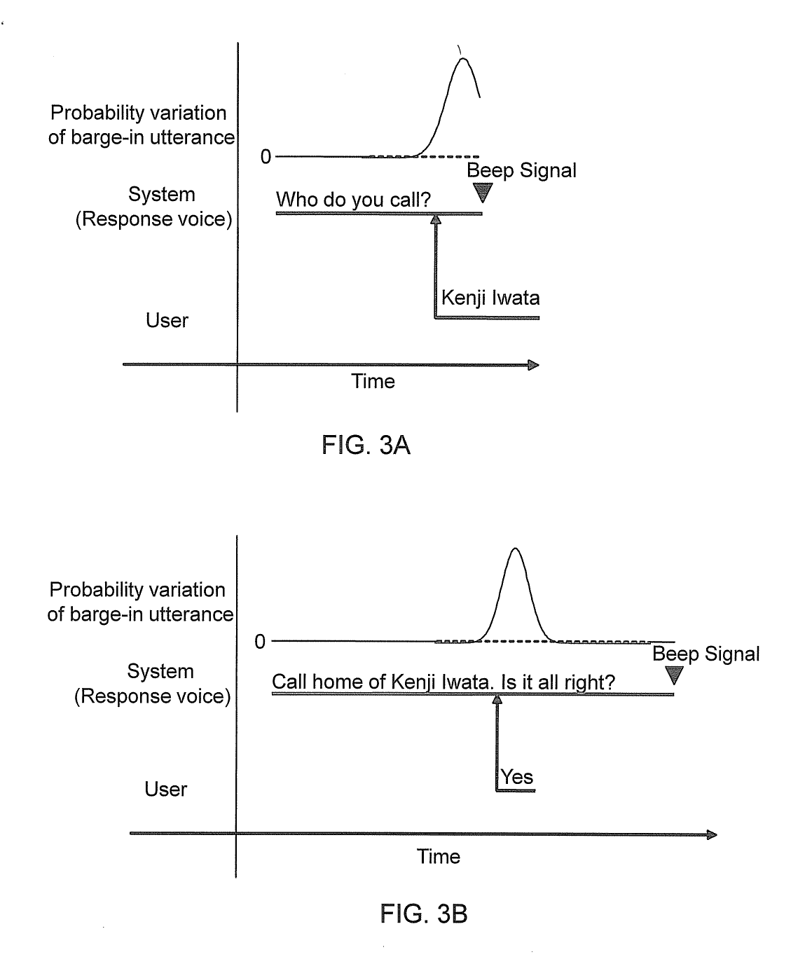

FIGS. 3 to 5 illustrate a method that the estimate unit 15 estimates the probability variation of the barge-in utterance.

It is explained that the estimate unit 15 estimates the period easier to arise the barge-in utterance based on voice data of the response voice sentence.

When the speaker 62 finished outputting the response voice, a beep signal sounds. The beep signal indicates to the user that the response voice of the apparatus 1 is finished. The apparatus 1 prompts the user to reply with his voice.

In FIGS. 3 to 5, a graph shown on the response voice is an example of the probability variation of the barge-in utterance estimated by the estimate unit 15. A dotted line shows that the probability of the barge-in utterance is substantially 0 (zero). If a solid line is higher than the dotted line, the period indicates a greater likelihood of the barge-in utterance.

FIG. 3 case is effective to beginner users who are not familiar with the system 100. Beginners do not know how to use the system 100. Beginners usually do not pronounce until finishing outputting the response voice. But if beginners make a mistake that an output of the response voice is finished, they tend to make a barge-in utterance.

The probability variation of the barge-in utterance shown in FIG. 3A is estimated that the barge-in utterance happens easily just before output of the response voice is finished. The probability variation of the barge-in utterance shown in FIG. 3B is estimated that the barge-in utterance happens easily at the period of pause during output of the response voice is finished. The pause occurs between output sentences.

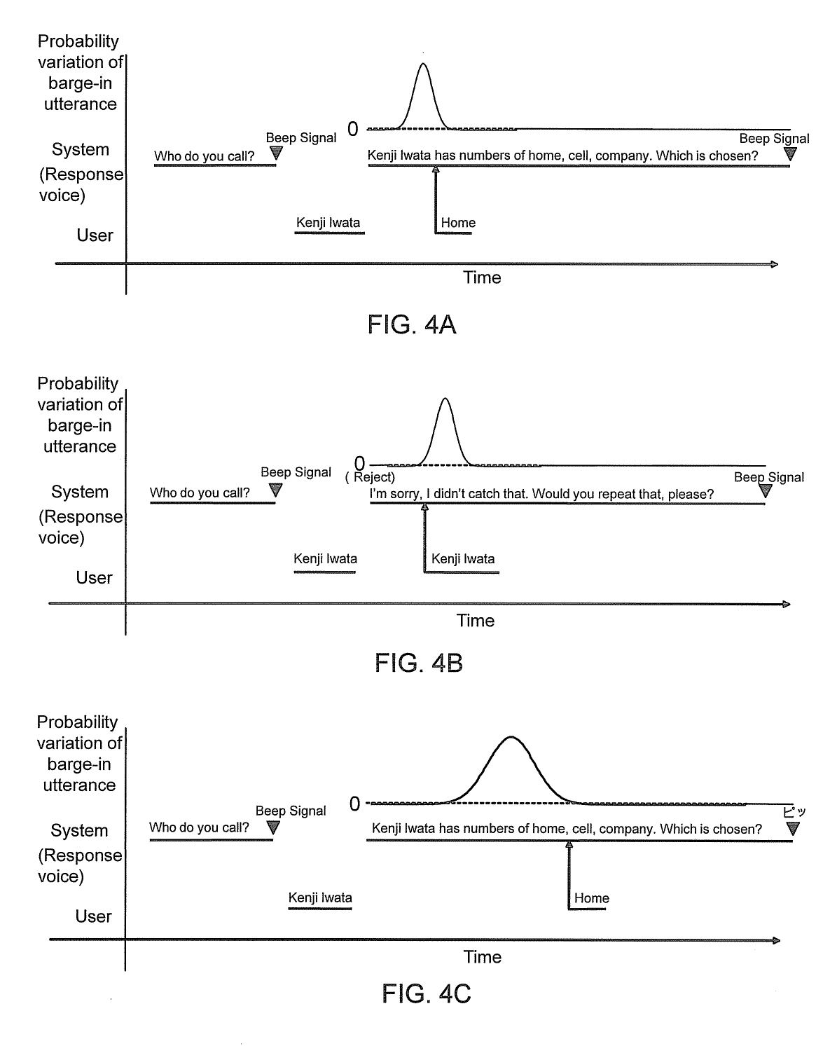

FIG. 4 indicates that the probability variation of the barge-in utterance is effective for skilled users. Skilled users know what next should be said in a state of the present dialogue. When skilled users grasp whether the result of the speech recognition is correct based on the output of the response voice, they tend to make a barge-in utterance.

The probability variation of the barge-in utterance shown in FIG. 4A is estimated that the recognition unit 12 recognizes a user's voice and the barge-in utterance happens likely just after the result of the recognition outputted by the output unit 14 (that is to say “Talk-Back”).

The probability variation of the barge-in utterance shown in FIG. 4B is estimated that the recognition unit 12 does not recognize a user's voice (that is to say “Reject”) and the barge-in utterance happens likely during the period when the user understands that the user is under request for re-utterance (for example, just after response “I′m sorry”).

If candidates for words spoken by the user are outputted as choices, the user tends to make a barge-in utterance at the period of outputting the candidates. So, the probability variation of the barge-in utterance shown in FIG. 4C is estimated that the barge-in utterance happens likely during the period when the user is outputted as the candidates (for example, Home, Cell phone or Company).

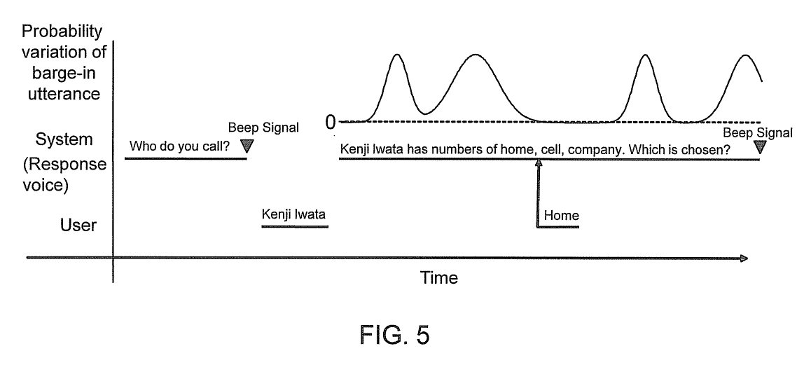

To merge the probability variation of the barge-in utterance shown in FIG. 3 and the probability variation of the barge-in utterance shown in FIG. 4 results in the probability variation of the barge-in utterance shown in FIG. 5.

In this case, the estimate unit 15 finally estimates the probability variation of the barge-in utterance shown in FIG. 5 and provides the probability variation to the control unit 13.

The control unit 13 adjusts the standard of whether to adopt the result of recognizing the barge-in utterance. The control unit 13 sets up a threshold value concerning a confidence score that is obtained with the result of the speech recognition. When the confidence score is less than or equal to the threshold value, the control unit rejects the result of the speech recognition and changes the threshold value based on the probability variation of the barge-in utterance.

The probability variation of the barge-in utterance shown in FIGS. 3 to 5 is changed continuously. However the probability variation of the barge-in utterance can be changed discretely. In a similar way, the standard of whether to adopt the barge-in utterance can be changed continuously or discretely.

The estimate unit 15 estimates the probability variations of the barge-in utterance based on the response voice in the first embodiment. However the estimate unit can have a table (not shown) of the probability variations of the barge-in utterance corresponding to the response voices. The estimate unit can extract the probability variation of the barge-in utterance corresponding to the response voice from the table and can provide the extracted probability variation of the barge-in utterance to the control unit 13.

### First Variation of the First Embodiment

In the flow chart shown in FIG. 2, the probability variation of the barge-in utterance is estimated before outputting the response voice and starting the speech recognition. However the probability variation of the barge-in utterance is utilized after the result of the speech recognition (Act 106).

Optionally, after obtaining the result of the speech recognition or starting-up the speech recognition, the probability variation of the barge-in utterance can be estimated based on the outputting response voice. The control unit 13 can adjust the standard of whether to adopt the barge-in utterance based on the probability variation of the barge-in utterance.

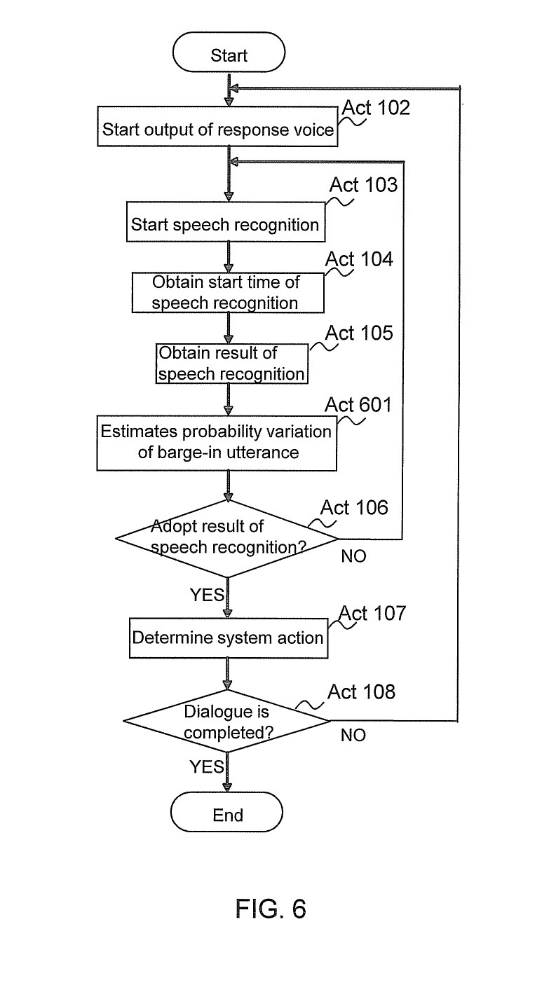

FIG. 6 illustrates a flow chart of the operation of the spoken dialogue apparatus 1 according to a first variation of the first embodiment. The probability variation of the barge-in utterance is estimated after obtaining the result of the speech recognition (Act 601). The control unit 13 determines whether to adopt the result of the speech recognition based on the probability variation of the barge-in utterance (Act 106).

There are four methods to make the probability variation of the barge-in utterance.

The first method is to make the probability variation of the barge-in utterance correspond to the outputted response voice separately and read the probability variation of the barge-in utterance with the response voice.

When Talk-back and the following response voice are outputted separately, the second method is to estimate that the period between Talk-back and the following response voice is estimated more likely that the barge-in utterance arises.

When the response voice is described by text characters and is outputted by synthesized speech, the third method is to add the probability variation of the barge-in utterance to the text characters.

When punctuation mark is detected by text analysis, the forth method is to estimate that the detected period is more likely that the barge-in utterance arises.

The process that determines whether to receive the barge-in utterance is explained and shown in FIG. 2.

There is another process that determines whether to receive the barge-in utterance shown in FIG. 6. When the response voice is outputted, the probability variation of the barge-in utterance is synchronized with the response voice. When the detection unit 11 starts to detect user's voice, the detection unit 11 determines the condition to receive the barge-in utterance at the starting time. When the recognition unit 12 obtains the result of the speech recognition, the control unit 13 checks the condition.

### Second Variation of the First Embodiment

When the response voice outputted by the speaker 62 inputs the microphone 61, the output response voice is mixed in user's input voice. In this case, a spoken dialogue apparatus 10 can include an echo cancellation unit 16 that uses the outputted response voice and removes the output response voice from the input signal inputted by microphone 61.

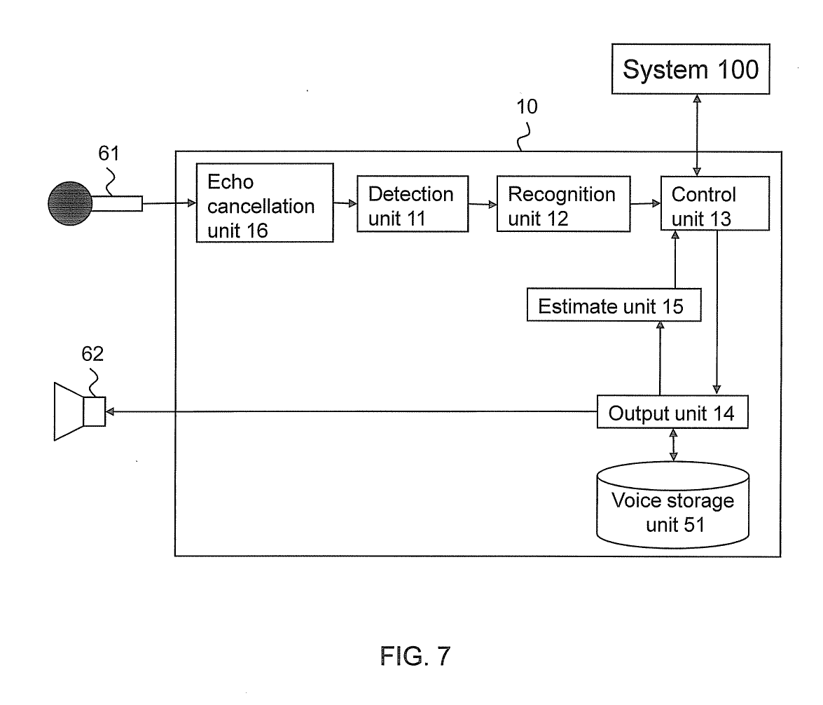

FIG. 7 illustrates a flow chart of the operation of the spoken dialogue apparatus 10 according to a second variation of the first embodiment. The apparatus 10 shown in FIG. 7 furthermore includes an echo cancellation unit 16 as compared with the apparatus 1 shown in FIG. 1. The echo cancellation unit 16 removes response voice outputted by the speaker 62 from signal inputted by microphone 61 based on the output response voice. The echo cancellation unit 16 provides the removed signal to the detection unit 11.

The echo cancellation unit 16 operates at least period outputting response voice out of the period between Act 103 and Act 105 shown in FIG. 6. The apparatus 10 includes barge-in utterance function and echo cancellation function.

### Third Variation of the First Embodiment

The first embodiment explains but is not limited to, the method for determining whether to receive barge-in utterance based on the probability variation of the barge-in utterance.

For example, the probability variation of the barge-in utterance is set a predetermined threshold value. When the probability variation of the barge-in utterance is higher than the threshold value, the control unit 13 adopts the result of the speech recognition. When the probability variation of the barge-in utterance is smaller than the threshold value, the control unit 13 does not adopt the result of the speech recognition.

The spoken dialogue apparatus described in the first embodiment reduces false detection caused by a user's mutter and noise, while the barge-in utterance does not arise.

### Second Embodiment

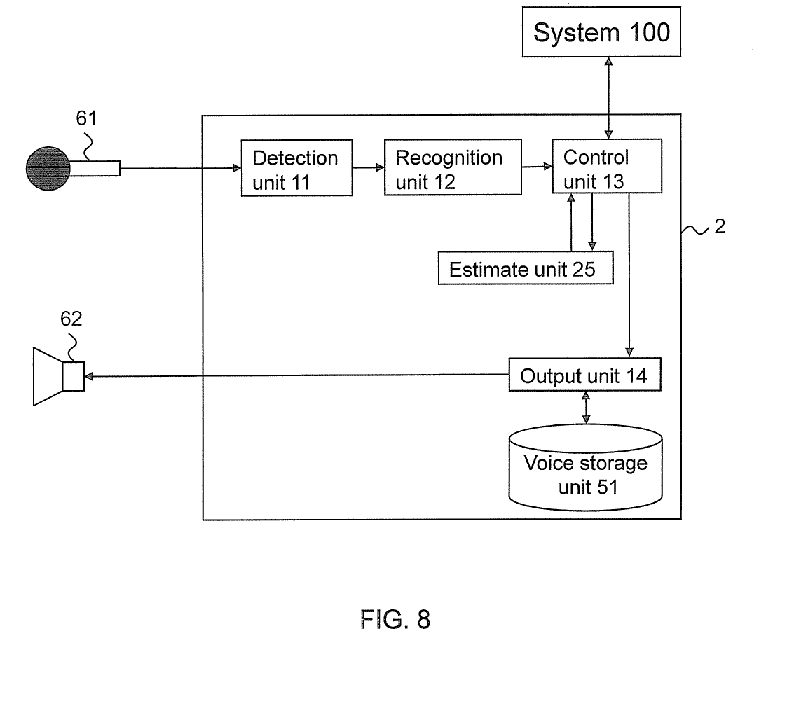

FIG. 8 shows the entire of a spoken dialogue apparatus 2 according to a second embodiment. The apparatus 2 includes estimate unit 25 that is different from estimate unit 15 shown in FIG. 1.

The differences between the first embodiment and the second embodiment are that the control unit 13 determines the following system action based on the result of the speech recognition and provides the following system action to the output unit 14 and the estimate unit 25.

The output unit 14 differs from the first embodiment in that the output unit 14 does not provide the output response voice to estimate unit 25.

The estimate unit 25 estimates the probability variation of the barge-in utterance based on the following system action and provides the probability variation of the barge-in utterance to the control unit 13.

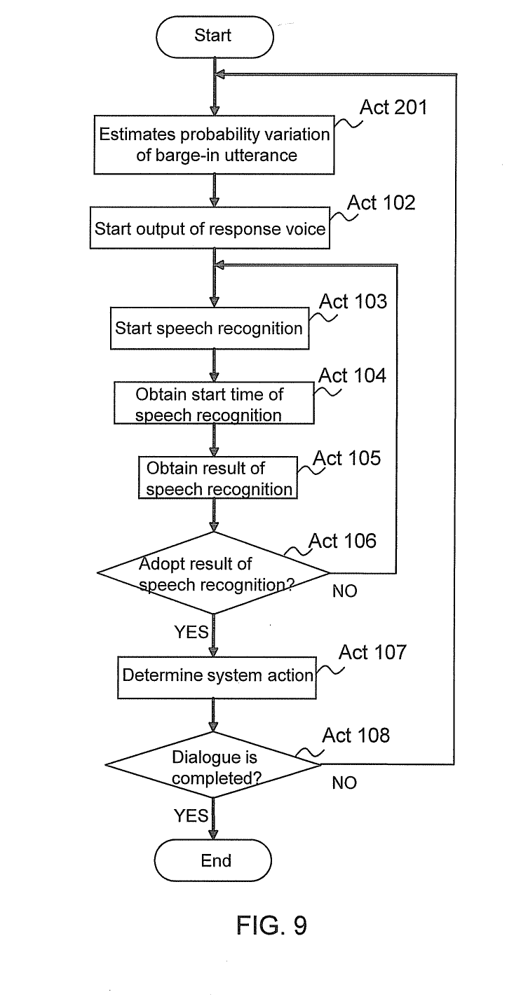

FIG. 9 illustrates a flow chart of the operation of the apparatus 2. The flow chart between Act 102 and Act 108 is similar to the first embodiment.

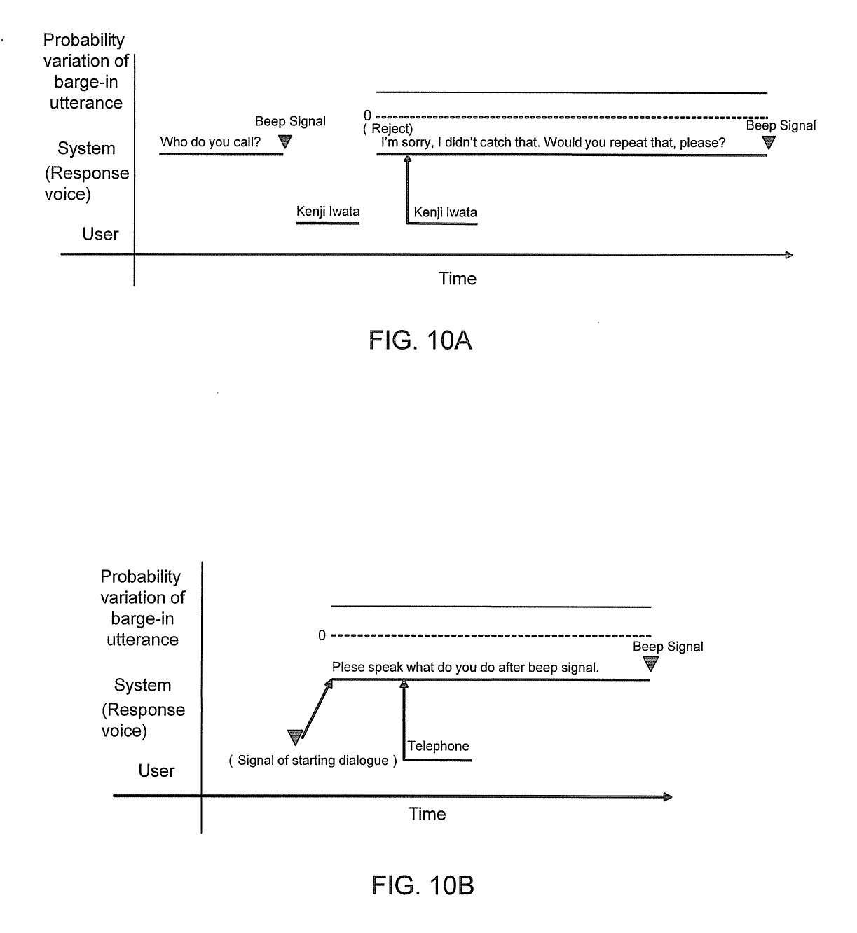

FIGS. 10A and 10B illustrate a method that an estimate unit 25 estimates the probability variation of the barge-in utterance according to the system action in Act 201.

The estimated probability variation of the barge-in utterance shown in FIG. 10A indicates that the barge-in utterance is more likely to arise at the period of the response voice after a user's voice is rejected. When the user utters same contents again after the rejection, the user tends to feel an urge for a barge-in utterance.

The beginning system action after starting dialogue outputs always the same response voice to demand the user in the similar way. If the user is skilled user, the user knows what should be spoken at the time when the signal of starting dialogue is noticed. So the user tends to feel barge-in utterance.

The estimated probability variation of the barge-in utterance shown in FIG. 10B indicates that the barge-in utterance is more likely to arise at the period of outputting the response voice after the dialogue starts.

In the second embodiment, the system action that is easier for users to make the barge-in utterance, tends to adopt the result of the speech recognition of the barge-in utterance while outputting response by the system action after rejection or after starting dialogue. The spoken dialogue apparatus described in the second embodiment reduces false detection caused by user's mutter and noise, while the barge-in utterance is not arisen.

### Third Embodiment

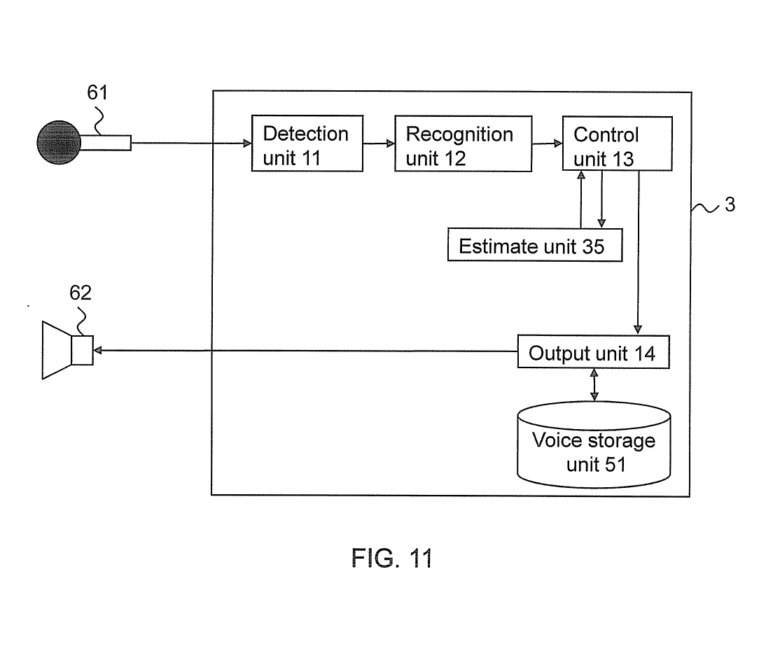

FIG. 11 shows the entire of a spoken dialogue apparatus 3 according to a third embodiment. The apparatus 3 includes estimate unit 35 that is different from estimate unit 25 shown in FIG. 8.

The differences between either the first or the second embodiment and the third embodiment are that the control unit 13 determines the following system action based on the result of the speech recognition, estimates the learning level of user about the system action and provides the learning level to the estimate unit 35.

The output unit 14 differs from the first embodiment in that the output unit 14 does not provide the output response voice to estimate unit 35.

The estimate unit 35 estimates the probability variation of the barge-in utterance based on the user's learning level according to the following system action and provides the probability variation of the barge-in utterance to the control unit 13.

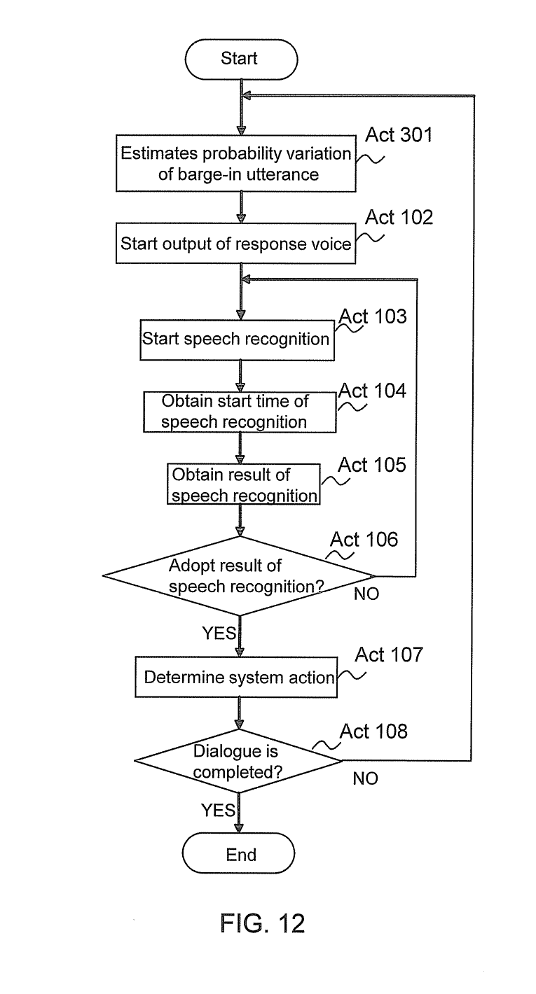

FIG. 12 illustrates a flow chart of the operation of the apparatus 3. The flow chart between Act 102 and Act 108 is similar to the first embodiment.

The estimate unit 35 estimates the probability variation of the barge-in utterance based on the user's learning level about the next system action in Act 301.

When the user is skilled the system action, the user knows what should be said next and the barge-in utterance tends to arise according to the output response of the system action.

The control unit 13 estimates the user's learning level about the next system action. The estimate unit 35 estimates the barge-in utterance more likely to arise if the user's learning level is higher.

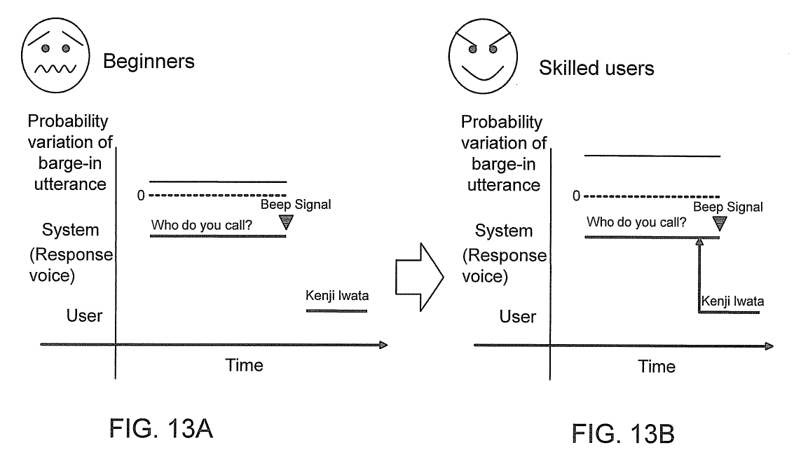

FIGS. 13A and 13B illustrate a method that an estimate unit 35 estimates probability variation of the barge-in utterance. In FIG. 13A, when estimate unit 35 estimates that the user is beginner and is not skilled in interacting with the system action, it is difficult for apparatus 3 to receive a barge-in utterance.

In FIG. 13B, when estimate unit 35 estimates that the user is skilled in interacting with the system action, it is easy for apparatus 3 to receive barge-in utterance. When the user is skilled and hopes to make the barge-in utterance, a level or threshold whether to receive the barge-in utterance rises.

It is able to combine the third embodiment with the first embodiment. When the user is skilled and the system action tends to rise the barge-in utterance, there are two methods that it is most likely to receive the barge-in utterance while outputting the response voice.

The first method is to add the standard of whether to adopt the barge-in utterance in the first embodiment to adopting the result of recognizing the barge-in utterance at the entire period. The second method is to add adopting the result of recognizing the barge-in utterance to the period estimated as tending to receive barge-in utterance in the first embodiment.

The method for estimating the learning level is to estimate based on the number of starting-up the system 100 or the number of the system action for the user. To be precise, the method is to estimate based on the decision tree of dialogue history.

In the third embodiment, the system action that is easier for skilled users to do the barge-in utterance, tends to adopt the result of the speech recognition of the barge-in utterance while outputting response by the system action. The spoken dialogue apparatus described in the third embodiment reduces false detection caused by user's mutter and noise, while the barge-in utterance is not arisen.

### Fourth Embodiment

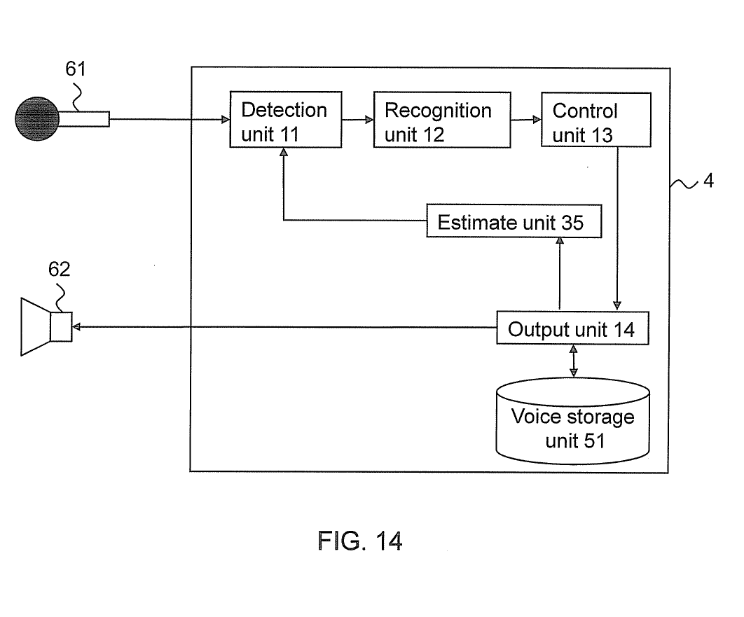

FIG. 14 shows the entire of a spoken dialogue apparatus 4 according to a fourth embodiment. It differs from the first embodiment in that the detection unit 11 of the fourth embodiment adjusts the standard of whether to detect starting point of voice, based on the probability variation of the barge-in utterance provided by the estimate unit 35.

The fourth embodiment differs from the first embodiment in that the control unit 13 of the fourth embodiment does not adjust the standard of whether to adopt the result of the speech recognition, based on the probability variation of the barge-in utterance while outputting the response voice.

The fourth embodiment differs from the first embodiment in that the estimate unit 35 of the fourth embodiment provides the probability variation of the barge-in utterance to the detection unit 11.

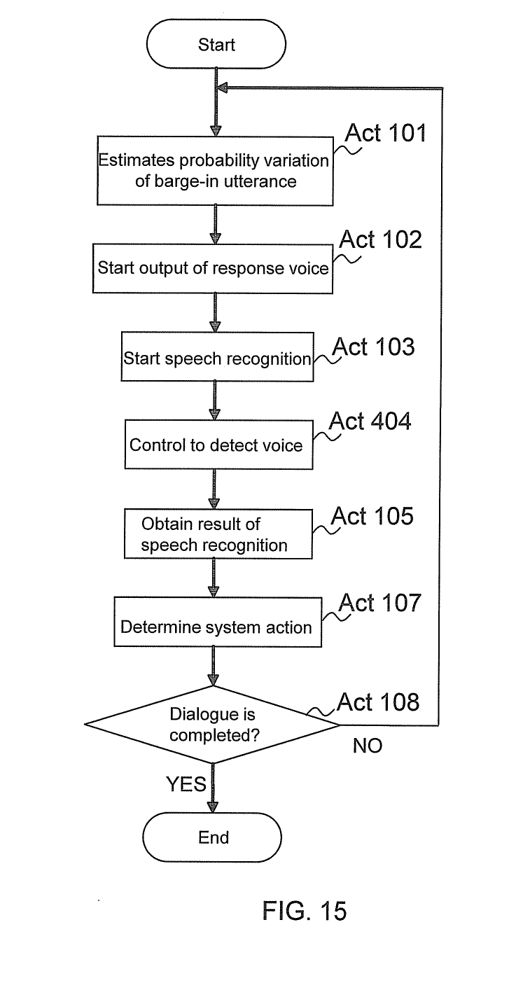

FIG. 15 illustrates a flow chart of the operation of the apparatus 4. The flow chart between Act 101 and Act 103, Act 105, Act 107 and Act 108 are similar to the first embodiment.

In Act 404, the detection unit 11 adjusts the standard of whether to detect starting point of voice, based on the probability variation of the barge-in utterance estimated by the estimate unit 35. And the recognition unit 12 performs speech recognition.

When the barge-in utterance is likely to arise, it is adjusted easy to detect starting point of voice. When the barge-in utterance is unlikely to arise, it is adjusted not to detect starting point of voice.

If once the detection unit 11 detects the starting point of a voice, it is required to prevent falsely stopping the detection of a user's voice. So the detection unit 11 maintains the standard of detection at the time detecting the starting point of the voice or fixes the predetermined standard of detection, until determining the end point of the voice. And the recognition unit 12 can maintain performing speech recognition with detecting the voice.

The method of adjusting the standard of whether to detect the starting point of the voice is to adjust parameter of the apparatus detecting voice interval, for example, to adjust the threshold of sound volume or the standard of whether to be human voice. The method of adjusting can be changed continuously or discretely.

In Act 404, when the barge-in utterance is unlikely to arise, the detection unit 11 is adjusted not to detect starting point of voice. As a result, Act 106 in FIG. 2 is unnecessary. The method directly moves from Act 105 to Act 107. And the action of the next dialogue can be determined.

In the fourth embodiment, the estimate unit 35 estimates the standard to arise the barge-in utterance based on the outputted response voice while outputting the response voice. When the barge-in utterance is estimated likely to arise, the detection unit 11 is adjusted easy to detect starting point of voice.

The spoken dialogue apparatus described in the fourth embodiment reduces false detection caused by user's mutter and/or noise, while the barge-in utterance is not arisen.

### One Variation of the Fourth Embodiment

The method for determining to receive the barge-in utterance based on the probability variation of the barge-in utterance is to adjust the standard of whether to detect the starting point of the voice based on the probability variation of the barge-in utterance and to adjust parameter of the apparatus detecting voice interval.

The other method is to set up the threshold of the probability variation of the barge-in utterance and to operate the detection unit 11 while being larger than the threshold. Or another setting-up parameter of the detection unit 11 is not to detect voice.

When the starting point of the voice is detected, the detection unit 11 is maintained to detect voice by setting-up the action of the detection unit 11 or the parameter of the speech detection unit to perform the detection of the voice until the detection unit 11 determines that the voice is finished.

When the detection of the voice is not performed and the probability variation of the barge-in utterance is smaller than the threshold, the detection unit 11 is not operated or the parameter of the speech detection unit is set up not to detect voice.

According to the spoken dialogue apparatus of at least one embodiment described above, the apparatus is able to recognize the barge-in speech high-precisely.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A spoken dialogue apparatus comprising:
a detection unit configured to detect speech of a user;
a recognition unit configured to recognize the speech;
an output unit configured to output a response voice corresponding to the result of speech recognition;
an estimate unit configured to estimate probability variation of a barge-in utterance, the probability variation of the barge-in utterance being the time variation of the probability of arising the barge-in utterance interrupted by the user during outputting the response voice; and
a control unit configured to determine whether to adopt the barge-in utterance based on the probability variation of the barge-in utterance.

2. The apparatus according to claim 1, wherein the control unit lowers a standard of adopting the result of the speech recognition of the barge-in utterance, when the probability variation of the barge-in utterance is higher.

3. The apparatus according to claim 1, wherein the control unit controls the output unit to output the response voice according to the barge-in utterance, when the barge-in utterance is adopted.

4. The apparatus according to claim 1, wherein the control unit further changes precision of detecting the speech of the detection unit based on the probability variation of the barge-in utterance.

5. A spoken dialogue method comprising:
detecting speech of a user;
recognizing the speech;
outputting a response voice corresponding to the result of speech recognition;
estimating probability variation of a barge-in utterance, the probability variation of the barge-in utterance being the time variation of the probability of arising the barge-in utterance interrupted by the user during outputting the response voice; and
determining whether to adopt the barge-in utterance based on the probability variation of the barge-in utterance.

6. The method according to claim 5, wherein a standard of adopting the result of the speech recognition of the barge-in utterance is lowered, when the probability variation of the barge-in utterance is higher.

7. The method according to claim 5, wherein the response voice according to the barge-in utterance is outputted, when the barge-in utterance is adopted.

8. The method according to claim 5, wherein further changing precision of detecting the speech of the detection unit based on the probability variation of the barge-in utterance.

9. A computer program product having a computer readable medium including programmed instructions for performing a spoken dialogue processing, wherein the instructions, when executed by a computer, cause the computer to perform:
detecting speech of a user;
recognizing the speech;
outputting response voice corresponding to the result of speech recognition;
estimating probability variation of a barge-in utterance, the probability variation of the barge-in utterance being the time variation of the probability of arising the barge-in utterance interrupted by the user during outputting the response voice; and
determining whether to adopt the barge-in utterance based on the probability variation of the barge-in utterance.

10. The method according to claim 9, wherein a standard of adopting the result of the speech recognition of the barge-in utterance is lowered, when the probability variation of the barge-in utterance is higher.

11. The method according to claim 9, wherein the response voice according to the barge-in utterance is outputted, when the barge-in utterance is adopted.

12. The method according to claim 9, wherein further changing precision of detecting the speech of the detection unit based on the probability variation of the barge-in utterance.
